(19) United States
(12) Patent Application Publication
(10) Pub. No.: US 2017/0258078 A1
(43) Pub. Date: Sep. 14, 2017

(54) USE OF A BLEND, ADJUVANT COMPOSITION FOR DRIFT REDUCTION, USE THEREOF, AGROCHEMICAL FORMULATION AND SPRAY MIX

(71) Applicant: OXITENO S.A. INDÚSTRIA E COMÉRCIO, Sao Paulo (BR)

(72) Inventors: Fernanda de Oliveira Barreto COSTA, Sao Paulo (BR); Thiago Melozo WALDRIGUI, Sao Paulo (BR)

(21) Appl. No.: 15/456,129

(22) Filed: Mar. 10, 2017

(30) Foreign Application Priority Data
Mar. 11, 2016 (BR) BR1020160054699

(51) Int. Cl. A01N 25/24; A01N 57/20; A01N 37/40; A01N 39/04

(52) U.S. Cl. CPC A01N 25/24; A01N 39/04; A01N 57/20; A01N 37/40

(57) ABSTRACT

This invention describes an adjuvant composition comprising a blend containing fatty acid esters with an alkoxylated polyol for drift reduction during the application of agrochemical product. This invention further describes the incorporation of this adjuvant composition in agrochemical formulations or the addition thereof in a step prior to its application, directly in the spray mix. The adjuvant composition described in this invention is compatible with a great variety of pesticides and inert components used in agrochemical compositions and proved to be able of reducing the formation of fine droplets, responsible for the formation of drift in more than one type of nozzle, without increasing the relative amplitude of the droplet spectrum, thus avoiding compromising the effectiveness of the active ingredient.

### CROSS-REFERENCE TO RELATED APPLICATIONS

This application claims priority to Brazilian Patent Application No. BR1020160054699, filed Mar. 11, 2016, which is herein incorporated by reference in its entirety.

### FIELD OF THE INVENTION

This invention relates to an adjuvant composition for drift reduction in the application of agrochemical products by spray or aerosol methods. This invention further describes the use of this adjuvant composition in the manufacture of agrochemical products or in the step preceding the application thereof.

### BACKGROUND OF THE INVENTION

The use of agrochemical products plays an important role in the production of food, as they are essential to increase crop productivity and, thus, to meet the growing demand caused by the rapidly growing world population. Among agrochemical products we can mention:

i) Pesticides or agricultural pesticides, which consist of formulations with one or more active ingredients effective in pest and disease control and are commonly classified according to their use, wherein herbicides, insecticides, fungicides, nematicides and acaricides are the most commonly used. The pesticides are rarely applied in the pure form, as the products found in the market are usually formulations comprising one or more active ingredients (AI) and other substances classified as inert, which enhance their effects and facilitate their application. When these inert compounds aid the action of the AI and/or modify the physico-chemical characteristics of each spray, they are called adjuvants.

ii) Foliar fertilizers and stimulants have the function of supplying compounds necessary to the vitality of the plants and, as 2/15 pesticides, they are usually formulations comprising compounds providing nutrition, fertilization or stimulation and other substances classified as inert, which enhance their effects and facilitate their application.

iii) The adjuvants of the mix, consisting of formulations of surfactants and other components that are applied by the farmer in the preparation of mixes of pesticides, foliar fertilizers and stimulants to enhance or improve the effect of these products through synergistic effects with the active ingredients of formulations, and, equally important, to facilitate the application condition. Let us mention a lot of examples of these effects: Improved spreadability and adhesiveness of the products on the leaf surface, improved penetration of the desired compounds into the plant, conditioning of the water used in the preparation of the mix, either to obtain a suitable pH range or to minimize the negative effect of salts that affect the formulation components, improved resistance to loss due to rain, which may occur after application, reduction of foam in the preparation of the mix, and loss of product due to droplet transport or volatilization to areas that are not the target of the treatment. The term mix is used to describe the dilution of the agrochemical products in water (diluent used in most of the cases) or oil, in the step prior to spraying. This dilution is necessary to facilitate the application of the products and to guarantee homogeneous distribution of a small amount of the active ingredient in a large treated area.

Adjuvants can be applied in two ways: incorporated into the formulation of the agrochemical products during their manufacture or added by the farmer in the step prior to spraying the product directly into the mix.

One of the most significant problems of agriculture is the loss of agrochemical product by drift. Drift is defined as the amount of agrochemicals used for plant protection, which are diverted out of the target by streams of air at the time of application by means of aerosols or spray. It is a complex phenomenon and it can be affected by several factors, among which, let us stress: climatic conditions at the time of application, the used application technology, the aerosol generating mechanical apparatus, the characteristics of the environment and the physical and chemical characteristics of the applied liquid.

It is widely known that the intensive use of agrochemical products combined with a formulation or unsuitable application of these products makes drift one of the major problems of current agriculture, causing risks to human health and negative impacts on the environment, as well as increasing production costs and reducing productivity, as it is believed that 10 to 15% of spray mix is lost to the environment due to the drift effect.

Within this scenario, the use of adjuvant products in the concentrated agrochemical formulation or directly in the spray mix that provide improvements in the efficiency and performance of agrochemicals, reducing drift and consequently causing less environmental and human health impact would be highly desirable.

The main variable related to drift occurrence is the size of the droplet formed in the spraying process. It is commonly recognized in scientific literature that droplets smaller than 200 micrometers significantly contribute to drift. For instance, ASTM E-2798-11, US test procedure to characterize the performance of adjuvants for drift control in terrestrial applications, considers that the fine droplets susceptible to drift are droplets smaller than 105 micrometers. In this invention, fine droplets were defined as droplets smaller than 200 micrometers.

If, on the one hand, fine droplets have a negative effect due to the occurrence of drift, on the other hand, very large droplets can compromise the effectiveness of the applied products, as large droplets tend to flow or drip from leave surface, and thus cannot guarantee a suitable coverage of the applied agrochemical product. Adjuvants that act only in the reduction of fine droplets and cause the increase of large droplets can minimize drift, but compromise the effectiveness of the pesticide, as explained by U.S. Pat. No. 6,797,673 and summarized in the article by Hilz and Veermer (Spray drift review: The extent to which a formulation can contribute to spray drift reduction). Thus, a balanced adjustment of the droplet size for correct application of agrochemicals is necessary.

The main classes of products used as adjuvants for drift control are high molecular weight hydrosoluble polymers, such as polyacrylamides (U.S. Pat. No. 6,288,010B1) and guar gum (U.S. Pat. No. 5,824,797A), and emulsified oils (U.S. Pat. No. 6,797,673B1).

The polymers used in this application increase the extensional viscosity and cause the jet to withstand deformation, forming larger droplets, thus impacting the bio-efficacy of the agrochemical product. This effect can be measured by the relative amplitude of the size of the formed droplets, which can be defined as the difference between the diameter of 90% of the accumulated volume and the diameter of 10% of the accumulated volume divided by the volumetric median diameter (VMD). Other disadvantages of some of these products are that they are sensitive to shear undergone during the application process and may be sensitive to variations in pH and presence of salts as addressed in U.S. Pat. No. 5,824,797 and the aforementioned article.

Emulsified oils are another class of products used as adjuvants for drift reduction. The suitable formulation of these products, which comprises oil, surfactants and a suitable ratio between them is essential to achieve a drift reduction effect. A disadvantage of some of these products is the variation of the performance according to the type of nozzle used, wherein the reverse effect, that is, increasing the amount of fine droplets, when using air induction nozzles in some of these systems, can occur as proven by Spanogue et al (Influence of agricultural adjuvants on droplet spectra), as well as by Buttler Ellis and Tuck (The variation in the characteristics of Air-Included Sprays with adjuvants).

Ethoxylated and propoxylated polymers in block Arrangement, as described in the claims of US patents N°s. US 2015/0150249 A1 and US2006/0180677 A1 are described as efficient to reduce drift, since these compounds confer this effect only upon air induction nozzles, limiting greatly its practical use. It is well-known in the prior art that the air induction nozzle significantly reduces the percentage of small diameter droplets and minimizes the occurrence of drift, but leads to the formation of very large droplets which may compromise the spread and coverage of the product on the plant surface. Thus, the development of chemical solutions for efficient drift control in different types of nozzles is necessary for the evolution of the technique of agrochemical product application.

To solve this problem, it has now been surprisingly verified that the use of esterified alkoxylated polyols causes the reduction of fine droplets during the spraying of agrochemicals without compromising the relative amplitude of droplet size. Furthermore, the reduction effect is kept by using both a traditional nozzle—more susceptible to drift—and an air induction nozzle.

Hence, this invention describes a novel adjuvant composition for drift reduction which confers fine droplet reduction, both for use in traditional nozzles and in air induction nozzles, without conferring an increase of droplet relative amplitude. These and other advantages of this invention will be evident in the following description.

### SUMMARY OF THE INVENTION

The present invention relates to an adjuvant composition comprising a blend of esters for drift reduction in the application of agrochemical products, such as herbicides, insecticides, fungicides, nematicides and acaricides, etc., by spray or aerosol methods. This invention further describes the use of the adjuvant composition in the manufacture of agrochemical formulations or the addiction thereof directly in the step of preparing the spray mix prior to its application in the crop.

### DETAILED DESCRIPTION OF THE INVENTION

The adjuvant composition of this invention comprises a blend comprising fatty acid esters with an esterified alkoxylated polyol for drift reduction in the application of agrochemicals such as pesticides, foliar fertilizers, stimulants, etc. by spray or aerosol methods.

In particular, the adjuvant composition of this invention comprises 0.1 to 30% by weight of a blend of two or more esters selected from di-, tri-, tetra-, penta- and hexaesters of an alkoxylated polyol having more than 120 moles of the alkoxide per mole of polyol, and whose minimum content of tetra- and penta-esters corresponds to about 30% by weight of the total esters, 2 to 12% of polyethylene glycol esters, 30 to 60% by weight of ethoxylated sorbitan esters, and 10 to 30% by weight of glycols. Such a composition is solid at room temperature and can be formulated for ease of handling and incorporation into agrochemical formulations. Moreover, the adjuvant composition may further comprise one or more solvents, surfactants, compatibilizers, water and, optionally, defoamers.

Advantageously, it was observed that in higher concentration of the blend that comprises two or more of the aforementioned akoxylated polyol esters such as, for instance, 35 to 60%, the composition acts as an adjuvant in agrochemical formulations, causing a reduction of the drift effect. Due to the chemical nature of the esterified alkoxylated polyols used herein, the drift reduction adjuvant composition described in this invention is compatible and can be incorporated directly into concentrated agrochemical formulations in its manufacturing process, such as, for example, concentrated suspensions (CS), emulsifiable concentrates, among other types of formulation, or even added in a step prior to the application of the agrochemical formulation in the mix.

In the example shown in Table 1, the esterified alkoxylated polyol (sorbitol) was mixed with surfactants and solvents to obtain a product in the liquid state, making easier the incorporation if the product has no structure making component melting possible.

TABLE 1
Example of the use of the adjuvant composition for drift reduction
in the liquid form to be directly incorporate into agrochemical
formulations during their manufacture (ADJ - FORMULATION):

| Components | Percentage by weight, % w |
|---|---|
| Mixture of ethoxylated sorbitol esters | 40 |
| Polyethylene glycol esters | 30 |
| Ethoxylated sorbitan esters | 2 |
| Propylene glycol | 2 |
| Water (optional) | 26 |

In another preferable embodiment of this invention, the adjuvant composition can also be added by the farmer only in the final step, in the spray mix, as evidenced in Table 2 below. In this case, the suitable formulation with solvents and surfactants accelerate the homogenization of the adjuvant in the mix.

TABLE 2
Example of adjuvant composition for drift reduction in the
liquid form to be added to the spray mix (ADJ - MIX):

| Components | Percentage by weight, % w |
|---|---|
| Mixture of ethoxylated sorbitol esters | 8 |
| Polyethylene glycol esters | 6 |
| Ethoxylated sorbitan esters | 40 |
| Propylene glycol | 20 |
| Silicone defoamer | 0.1 |
| Water | 25.9 |

Another possible use implies the addition of esterified alkoxylated polyol formulated in an oil adjuvant formulation (Tables 3 and 4).

TABLE 3
Example of adjuvant composition for drift reduction
incorporated into an oily adjuvant of a mix to
be added to the spray mix (ADJ - OIL 80):

| Components | Percentage by weight, % w |
|---|---|
| Soy Methyl Ester | 80 |
| Linear Calcium Salt | 5 |
| Ethoxylated Lauryl Alcohol | 4 |
| Ethoxylated Castor Oil | 6 |
| 2-ethyl-hexanol | 2 |
| Adjuvant composition of table 1 | 1 |
| Water | 2 |

TABLE 4
Example of adjuvant composition for drift reduction in oily adjuvant
of the mix to be added to the spray mix: (ADJ - OIL 60):

| Components | Percentage by weight, % w |
|---|---|
| Soy Methyl Ester | 60 |
| Linear Calcium Salt | 10 |
| Ethoxylated Lauryl Alcohol | 8 |
| Ethoxylated Castor Oil | 12 |
| 2-ethyl-hexanol | 4 |
| Adjuvant composition of table 1 | 1 |
| Water | 5 |

In general, the amount of adjuvant composition used for drift reduction, as propounded in this invention, corresponds to about 0.05 and 10 by weight of the adjuvant composition, when used to prepare the agrochemical formulation and, preferably, this amount varies from 1 to 5%. In the spray mix, the adjuvant composition is added in an amount varying from 0.05 and 5%, preferably between 0.1 and 1% by weight. Moreover, one or more herbicides, insecticides, fungicides, acaricides, foliar fertilizers or other adjuvants with antifoaming, humectant, spreading, adhesive, compatibilizing, penetrating, acidifying, neutralizing, buffering features or water-conditioning agents can be also present. However, the exact amount of the adjuvant composition to be incorporated in each formulation or in the spray mix depends on its type, its components, process for preparing and reducing fine droplets to be achieved.

In these agrochemical products, it was found that the adjuvant composition of this invention causes the decrease of fine droplets, responsible for the formation of drift during spraying of agrochemical products. The composition prepared according to this invention has also other important characteristics such as not increasing the relative amplitude of the sprayed droplets and allowing the use of traditional flat jet or extended-range flat jet nozzles, in addition to air induction nozzles, maintaining the effect of fine droplet reduction.

It is worth stressing that, in the formulations and concentration ranges described in this invention, the adjuvant composition confers no thickening of the agrochemical product and maintains characteristics of Newtonian fluid in the mix dilution conditions. This fact confers an advantage to this adjuvant composition over the polymers used for drift control, which have pseudoplastic behavior even at low concentrations of the mix.

The following examples show several aspects of this Invention without, however, limiting it. The results described in the tables of each example prove the effect of the adjuvant composition in the reduction of fine droplets and, thus, of the drift.

### EXAMPLES

### Example 1

### Formulation of the 2.4 D Salt Containing the Adjuvant Composition for Drift Reduction of Table 1 (ADJ-FORMULATION)

2% by weight of the adjuvant composition of Table 1 was mixed with a formulation of the soluble concentrate type of 806g g/L of 2.4D, of dimethylamine salt. Two spray mixes containing the same content of 2.4D salt (1.84% p/v), one by adding 2% of the adjuvant composition and the other one with only 2.4D salt and water, were prepared. The mixes were applied using two types of nozzles: one of the extended-range flat jet type OCR 8002) and the other of the air induction type (AIXR11002) and pressure of 40 psi. The Volumetric Median Diameter (VMD), the % reduction of droplets smaller than 105 μm and the relative droplet size amplitude were analyzed. Droplet spectrum analyzes were performed by the VisiSizer Portable image analysis equipment manufactured by Oxford Lasers in a windless spray chamber.

TABLE 5
Droplet Spectrum Analysis of Example 1

| | Nozzles | | | | | |
|---|---|---|---|---|---|---|
| | XR8002 | | | AIXR11002 | | |
| | | % of | | | % of | |
| | | Droplet | | | Droplet | |
| | | Reduc- | | | Reduc- | |
| | DMV | tion <105 | Relative | DMV | tion <105 | Relative |
| | (μm) | μm | amplitude | (μm) | μm | amplitude |
| 2.4D | 131 | * | 1.38 | 260 | * | 1.60 |
| DMA | | | | | | |
| Salt | | | | | | |
| 2.4D | 139 | 17 | 1.36 | 309 | 50 | 1.41 |
| DMA | | | | | | |
| salt | | | | | | |
| formulated | | | | | | |
| with 2% | | | | | | |
| w of the | | | | | | |
| adjuvant | | | | | | |
| for drift | | | | | | |
| reduction | | | | | | |

### Example 2

### Spray Mix with 2.4 D DMA+DEA Salt and Mix Adjuvant for Drift Reduction of Table 2 (ADJ-MIX)

1% v/v of the herbicidal composition of 625 g/L of the 2.4 D (dimethylamine and diethanolamine salt) salts blend were mixed in the spray mix, using the commercial product Amicide 625 of the manufactures Nufarm and 0.25% v/v of the adjuvant composition shown in Table 2. The mixes were applied using two types of nozzles: one of the extended flat jet type (XR 8002) and the other of the air induction type (AIXR11002) and pressure of 40 psi. The Volumetric Median Diameter (VMD), the % reduction of droplets smaller than 105 μm and the relative droplet size amplitude were analyzed. Droplet spectrum analyses were performed by the laser diffraction analysis equipment Sympatec HELOS manufactured by Sympatec GmbH in wind tunnel with wind speed of 8 m/s.

TABLE 6
Droplet Spectrum Analysis of Example 2

| | Nozzles | | | | | |
|---|---|---|---|---|---|---|
| | XR8002 | | | AIXR11002 | | |
| | | Droplet | | | Droplet | |
| | | Reduction | Relative | | Reduction | Relative |
| | DMV | % <105 | ampli- | DMV | % <105 | ampli- |
| | (μm) | μm | tudee | (μm) | μm | tude |
| 2.4 D | 233 | * | 1.12 | 426 | * | 1.03 |
| DMA + DEA | | | | | | |
| 2.4 D | 235 | 14 | 1.12 | 416 | 11 | 1.06 |
| DMA + DEA + | | | | | | |
| 0.25% | | | | | | |
| ADJ-MIX | | | | | | |

### Example 3

### Spray Mix with Potassium Glyphosate Salt and Mix Adjuvant for Drift Reduction of Table 2 (ADJ-MIX)

In the spray mix, 2.5% v/v of the herbicidal composition of 540 g/L of potassium glyphosate salt were mixed with the 0.25% v/v of the adjuvant composition shown in Table 2, using the commercial product RoundUp Powermax manufactured by Monsanto. The mixes were applied using three types of nozzles: one of the flat jet type (8002), another of the extended-range flat jet type (XR 8002) and the other of the air induction type (AIXR11002) and pressure of 40 psi. The Volumetric Median Diameter (VMD), the % reduction of droplets smaller than 105 μm and the relative droplet size amplitude were analyzed. Droplet spectrum analyses were performed by the laser diffraction analysis equipment Sympatec HELOS manufactured by Sympatec GmbH in wind tunnel with wind speed of 8 m/s.

TABLE 7
Droplet Spectrum Analysis of Example 3

| | Nozzles | | | | | | | | |
|---|---|---|---|---|---|---|---|---|---|
| | 8002 | | | XR8002 | | | AIXR11002 | | |
| | | Droplet | | | Droplet | | | Droplet | |
| | DM V | Reduction | Relative | DM V | Reduction | Relative | DM V | Reduction | Relative |
| | (μm) | % <105 μm | amplitude | (μm) | % <105 μm | amplitude | (μm) | % <105 μm | amplitude |
| K | 214 | * | 1.32 | 176 | * | 1.45 | 377 | * | 1.26 |
| glyphosate | | | | | | | | | |
| K | 235 | 45 | 1.08 | 221 | 62 | 1.09 | 377 | 35 | 1.17 |
| glyphosate + | | | | | | | | | |
| 0.25% | | | | | | | | | |
| ADJ-MIX | | | | | | | | | |

### Example 4

### Spray Mix with Glyphosate Salt and Oil-Based Mix Adjuvant Containing the Adjuvant Composition for Drift Reduction in this Invention. According to tables 3 and 4 (ADJ-OIL 80 and OIL 60)

In the spray mix, 2.5% v/v of the herbicidal composition of 540 g/L of potassium glyphosate salt and 0.25% v/v of the adjuvant compositions shown in Table 3 were mixed, using the commercial product RoundUp Powermax manufactured by Monsanto. The mixes were applied using two types of nozzles: one of the extended-range flat jet type (XR 8002) and the other of the air induction type (AIXR11002) and pressure of 40 psi. The Volumetric Median Diameter (VMD), the % reduction of droplets smaller than 105 μm and the relative droplet size amplitude were analyzed. Droplet spectrum analyses were performed by the laser diffraction analysis equipment Sympatec HELOS manufactured by Sympatec GmbH in wind tunnel with wind speed of 8 m/s.

TABLE 8
Droplet Spectrum Analysis of Example 4

| | Nozzles | | | | | |
|---|---|---|---|---|---|---|
| | XR8002 | | | AIXR11002 | | |
| | | % of | | | % of | |
| | | Droplet | | | Droplet | |
| | | Reduc- | | | Reduc- | |
| | DMV | tion <105 | Relative | DMV | tion <105 | Relative |
| | (μm) | μm | amplitude | (μm) | μm | amplitude |
| Glypho- | 176 | * | 1.45 | 377 | * | 1.26 |
| sate K | | | | | | |
| K | 212 | 60 | 1.12 | 374 | 56 | 1.07 |
| Glypho- | | | | | | |
| sate + | | | | | | |
| 0.25% | | | | | | |
| ADJ- | | | | | | |
| OIL 80 | | | | | | |
| K | 206 | 35 | 1.26 | 392 | 42 | 1.07 |
| Glypho- | | | | | | |
| sate + | | | | | | |
| 0.25% | | | | | | |
| ADJ- | | | | | | |
| OIL 60 | | | | | | |

### Example 5

### Spray Mix with DGA Dicamba Salt and Mix Adjuvant for Drift Reduction of Table 2 (ADJ-MIX)

In the spray mix, 2.5% v/v of the herbicidal composition of 480 g/L of Dicamba, Diglycolamine salt (DGA) and 0.25% v/v of the adjuvant compositions shown in Table 2 were mixed, using the commercial product Clarity manufactured by BASF. The mixes were applied using two types of nozzles: one of the extended-range flat jet type (XR 8002) and the other of the air induction type (AIXR11002) and pressure of 40 psi. The Volumetric Median Diameter (VMD), the % reduction of droplets smaller than 105 μm and the relative droplet size amplitude were analyzed. Droplet spectrum analyses were performed by the laser diffraction analysis equipment Sympatec HELOS manufactured by Sympatec GmbH in wind tunnel with wind speed of 8 m/s.

TABLE 8
Droplet Spectrum Analysis of Example 5

| | Nozzles | | | | | |
|---|---|---|---|---|---|---|
| | XR8002 | | | AIXR11002 | | |
| | | % of | | | % of | |
| | | Droplet | | | Droplet | |
| | | Reduc- | | | Reduction | |
| | DMV | tion <105 | Relative | DMV | % <105 | Relative |
| | (μm) | μm | amplitude | (μm) | μm | amplitude |
| Dicamba | 225 | * | 1.16 | 412 | * | 1.00 |
| DGA | | | | | | |
| Dicamba | 246 | 42 | 1.10 | 421 | 20 | 1.05 |
| DGA | | | | | | |
| 0.25%. | | | | | | |
| ADJMIX | | | | | | |

Based on the data of the tables above it can be verified that the adjuvant composition of this invention causes the decrease of fine droplets, responsible for the formation of drift during spraying of agrochemical products.

Countless variations affecting the scope of protection of this application are allowed. Therefore, it is to be emphasized that this invention is not limited to the specific concentrations described above.

We claim:

1. A method of using an alkoxylated polyol blend for the preparation of an adjuvant composition for drift reduction in an agrochemical formulation, wherein the polyol blend comprises 0.05 to 40% by weight of two or more di-, tri-, tetra-, penta- and hexaesters of an alkoxylated polyol having more than 120 moles of alkoxide per mole of polyol, and wherein tetra- and penta-esters contain at least 30% by weight of the total esters,
comprising the step of adding the polyol blend to an agrochemical formulation, wherein the polyol blend improves the drift reduction properties in the agrochemical formulation.

2. An adjuvant composition for drift reduction, comprising
0.1 to 30% by weight of a blend of two or more esters of an alkoxylated polyol having more than 120 moles of alkoxide per mole of polyol, wherein the blend contains tetra and penta esters that comprise at least 30% by weight of the total esters,
2 to 12% by weight of polyethylene glycol esters,
30 to 60% by weight of ethoxylated sorbitan esters, and
10 to 30% by weight of glycols.

3. The adjuvant composition according to claim 2, further comprising water and, optionally, an antifoamer.

4. An agrochemical formulation, comprising 0.05 to 10% by weight of the adjuvant composition of claim 2.

5. An agrochemical formulation, comprising 1 to 5% by weight of the adjuvant composition of claim 2.

6. A spray mix, comprising 0.05 to 5% by weight of the adjuvant composition of claim 2.

7. A spray mix, comprising 0.1 to 1% by weight of the adjuvant composition of claim 2.

8. The agrochemical formulation of claim 4, further comprising one or more components selected from the group consisting of herbicides, insecticides, fungicides, acaricides, 2/2 foliar fertilizers, other adjuvants with antifoaming properties, humectant, spreader, adhesive, compatibilizing agents, penetrating agents, acidifying agents, neutralizing agents, buffering agents, water conditioning agents, and combinations thereof.

9. The agrochemical formulation of claim 5, further comprising one or more components selected from the group consisting of herbicides, insecticides, fungicides, acaricides, 2/2 foliar fertilizers, other adjuvants with antifoaming properties, humectant, spreader, adhesive, compatibilizing agents, penetrating agents, acidifying agents, neutralizing agents, buffering agents, water conditioning agents, and combinations thereof.

10. The agrochemical formulation of claim 8, wherein the adjuvant composition improves the drift reduction properties of the agrochemical formulation.

11. The agrochemical formulation of claim 9, wherein the adjuvant composition improves the drift reduction properties of the agrochemical formulation.

12. The spray mix of claim 6, wherein the adjuvant composition improves the drift reduction properties of the agrochemical formulation.

13. The spray mix of claim 7, wherein the adjuvant composition improves the drift reduction properties of the agrochemical formulation.
